(19) United States
(12) Patent Application Publication
(10) Pub. No.: US 2026/0119338 A1
(43) Pub. Date: Apr. 30, 2026

(54) APPARATUSES, SYSTEMS, AND METHODS FOR PRESERVING MEMORY SETTINGS AND DERIVING PARASITIC DRAW

(71) Applicant: Power Probe Group, Inc., Charlotte, NC (US)

(72) Inventors: David Douglas Barden, Crestline, CA (US); Danny J. Swerkes, Trabuco Canyon, CA (US)

(73) Assignee: Power Probe Group, Inc., Charlotte, NC (US)

(21) Appl. No.: 18/926,019

(22) Filed: Oct. 24, 2024

(51) Int. Cl. G06F 11/14; G06F 11/20; G06F 11/30

(52) U.S. Cl. CPC G06F 11/1469; G06F 11/2015; G06F 11/3062; G06F 2212/1032; G06F 2212/173

(57) ABSTRACT

Apparatuses, systems and methods for preserving memory settings and deriving parasitic draw of an electrical system of a vehicle include a power source configured to energize the electrical system and sensor(s) electrically coupled to the power source, where the sensor(s) are configured to detect current flow from the power source to the electrical system. An analyzer electrically coupled to the power source and sensor(s) is configured to derive a parasitic draw of the electrical system based on the detected current flow. The apparatus is electrically coupled to the power source via an interface configured to electrically connect to the electrical system. Based on the apparatus being electrically coupled, via the interface, to the electrical system while cable(s) of the electrical system are disconnected from a vehicle battery, the power source preserves memory settings of the electrical system and the analyzer derives the parasitic draw of the electrical system.

### FIELD OF THE INVENTION

This invention relates generally to apparatuses, systems, and methods for preserving memory settings and deriving parasitic draw, and more particularly, embodiments of the invention relate to apparatuses, systems, and methods where a power source of the apparatus preserves memory settings and an analyzer of the apparatus derives the parasitic draw of the electrical system of the vehicle.

### BACKGROUND OF THE INVENTION

Many vehicles, including various motor vehicles, railed vehicles, watercraft, amphibious vehicles, aircraft and spacecraft include various modules or other electrical systems to control various aspects of the vehicle. For instance, computer modules can programmed with various user-specified settings (e.g., radio presets, seat positions, temperature settings, etc.). In another example, engine control modules adapt fuel and spark controls over the life of the vehicle based on the driving style of the user that can be saved in order for the vehicle to run correctly. Users may utilize these programmed user-specified settings when the vehicle is in use in order to have a customized user experience. However, even when the vehicle is “turned off”, the vehicle constantly has a parasitic drain of electrical current that is drawn from the vehicle's battery while the vehicle is not in use partly in order to retain these user-specified settings. Generally, under “normal” conditions this parasitic drawn is less than 50 milliamps.

There are times when one or more battery cables are disconnected from battery terminals in order to measure parasitic draw or to replace the vehicle's battery. When the various modules or other electrical systems lose power, these user-specified settings can be lost, which can not only be an inconvenience to users but can also cause the vehicle to “forget” the fuel and spark controls, which may impact how well the vehicle operates. In particular, if the fuel and spark controls are sufficiently offset from the default trims, the vehicle may not be able to restart after temporarily losing battery power.

Existing apparatuses, systems, and methods intended to address these issues have various shortcomings. For instance, some vehicle maintenance procedures may require multiple devices to be plugged into various connection ports to connect to the vehicle's electrical system. However, some vehicles may not have enough connection ports to have all of the necessary devices simultaneously connected to the vehicle's electrical systems in order to perform various vehicle maintenance procedures, or it may be inconvenient to have multiple devices plugged into various connections ports of the vehicle at the same time. Therefore, some vehicle maintenance procedures may necessarily require that the vehicle be disconnected from the power source resulting in lost user-specified settings.

### BRIEF SUMMARY

Shortcomings of the prior art are overcome and additional advantages are provided through the provision of an apparatus for preserving memory settings and deriving parasitic draw of an electrical system of a vehicle. The apparatus includes a power source configured to energize the electrical system of the vehicle, as well as one or more sensors coupled to the power source. The one or more sensors are configured to detect current flow from the power source to the electrical system of the vehicle. Further, the apparatus includes an analyzer that is electrically coupled to the power source and the one or more sensors, where the analyzer is configured to derive a parasitic draw of the electrical system of the vehicle based on the current flow detected by the one or more sensors. The apparatus also includes an interface that is electrically coupled to the power source, where the interface is configured to electrically connect to the electrical system of the vehicle. Based on the apparatus being electrically coupled, via the interface, to the electrical system of the vehicle while one or more cables of the electrical system are disconnected from a vehicle battery of the vehicle, the power source preserves memory settings of the electrical system of the vehicle and the analyzer derives the parasitic draw of the electrical system of the vehicle.

Also disclosed herein is a system for preserving memory settings and deriving parasitic draw of an electrical system of a vehicle. The system includes a vehicle that includes the electrical system as well as an apparatus. The apparatus includes a power source that is configured to energize the electrical system of the vehicle and includes one or more sensors coupled to the power source, where the one or more sensors are configured to detect current flow from the power source to the electrical system of the vehicle. The apparatus also includes an analyzer that is electrically connected to the power source and the one or more sensors. The analyzer is configured to derive a parasitic draw of the electrical system of the vehicle based on the current flow that is detected by the one or more sensors. The apparatus also includes an interface that is electrically coupled to the power source, where the interface is configured to electrically connect to the electrical system of the vehicle. Additionally, based on the apparatus being electrically coupled, via the interface, to the electrical system of the vehicle while one or more cables of the electrical system are disconnected from a vehicle battery of the vehicle, the apparatus is configured to perform a method. The method includes preserving, by providing power via the power source, memory settings of the electrical system of the vehicle, and deriving, via the analyzer, the parasitic draw of the electrical system of the vehicle.

A method for preserving memory settings and deriving parasitic draw of an electrical system of a vehicle. The method includes energizing, based on an apparatus being temporarily connected via an interface to the electrical system of the vehicle, the electrical system of the vehicle via a power source of the apparatus. The method further includes preserving, based on the apparatus being connected and the electrical system being energized, memory settings of the electrical system of the vehicle. Additionally, current flow is measured, via one or more sensors of the apparatus, from the power source to the electrical system of the vehicle. The method also derives, via an analyzer of the apparatus, a parasitic draw from the electrical system of the vehicle, the parasitic draw being derived from the measured current flow. In addition, the energizing and preserving occur while one or more cables of the electrical system are disconnected from a vehicle battery of the vehicle.

Additional features and advantages are realized through the concepts described herein.

### BRIEF DESCRIPTION OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 depicts the front interior on the driver's side of a vehicle with a magnified view of a vehicle diagnostic port and an example apparatus for preserving memory settings and deriving parasitic draw of an electrical system of a vehicle, according to an implementation of the present disclosure;

FIG. 2 illustrates a perspective view of an example apparatus for preserving memory settings and deriving parasitic draw of an electrical system of a vehicle, according to an implementation of the present disclosure;

FIG. 3A illustrates a front elevational view of an example apparatus for preserving memory settings and deriving parasitic draw of an electrical system of a vehicle, according to an implementation of the present disclosure;

FIG. 3B illustrates bottom plan view of an example apparatus for preserving memory settings and deriving parasitic draw of an electrical system of a vehicle, according to an implementation of the present disclosure;

FIG. 3C illustrates a left side elevational view of an example apparatus for preserving memory settings and deriving parasitic draw of an electrical system of a vehicle, according to an implementation of the present disclosure;

FIG. 3D illustrates a back elevational view of an example apparatus for preserving memory settings and deriving parasitic draw of an electrical system of a vehicle, according to an implementation of the present disclosure;

FIG. 4A depicts a front elevational view of an apparatus for preserving memory settings and deriving parasitic draw of an electrical system of a vehicle, according to an implementation of the present disclosure;

FIG. 4B depicts a front elevational view of an example apparatus for preserving memory settings and deriving parasitic draw of an electrical system of a vehicle, according to an implementation of the present disclosure;

FIG. 5 depicts an example system for preserving memory settings and deriving parasitic draw of an electrical system of a vehicle, according to an implementation of the present disclosure; and

FIG. 6 depicts a block diagram of an example method for preserving memory settings and deriving parasitic draw of an electrical system of a vehicle, according to an implementation of the present disclosure.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. may be omitted to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Additionally, numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment”, “an embodiment”, “various embodiments”, “one or more embodiments”, etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described.

The terms “couple”, “coupled”, “couples”, “coupling”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. Additionally, “electrically coupled” and the like should be broadly understood and include coupling involving any electrical signal, whether a power signal, a data signal, and/or other types or combinations of electrical signals.

In addition, as used herein, the terms “about”, “approximately”, or “substantially” for any numerical values or ranges indicate a suitable dimensional tolerance that allows the device, part, or collection of components to function for its intended purpose as described herein. As used herein, the term “vehicle” is to be interpreted broadly to include any machine used to transport people or cargo including, for example, motor vehicles (e.g., motorcycles, cars, trucks, buses, mobility scooters, etc.), railed vehicles (e.g., trains, trams, etc.), watercraft (e.g., ships, boats, underwater vehicles, etc.), amphibious vehicles (e.g., hovercraft, screw-propelled vehicles, etc.), aircraft (e.g., airplanes, helicopters, etc.), and spacecraft.

Disclosed herein are example apparatuses, systems and methods for preserving memory settings and deriving parasitic draw of an electrical system of a vehicle, according to an implementation of the present disclosure. The disclosed invention overcomes shortcomings of existing technology by combining parasitic draw detection capabilities into a device that is used to preserve the memory of the vehicle's electrical settings. Advantageously, by combining these two technologies into a single device, since a power source of the device is being used to preserve the memory of the vehicle's electrical settings, which results in current flowing to the electrical system of the vehicle, the device can derive the parasitic draw from the current flow from a power source of the device to the electrical system of the vehicle. The invention not only requires a minimal number of connections to the electrical system, which can pose a challenge in some vehicles, but also facilitates safe disconnection or removal of the vehicle's battery without the risk of losing various user-specified settings or other system settings that are specific to the vehicle.

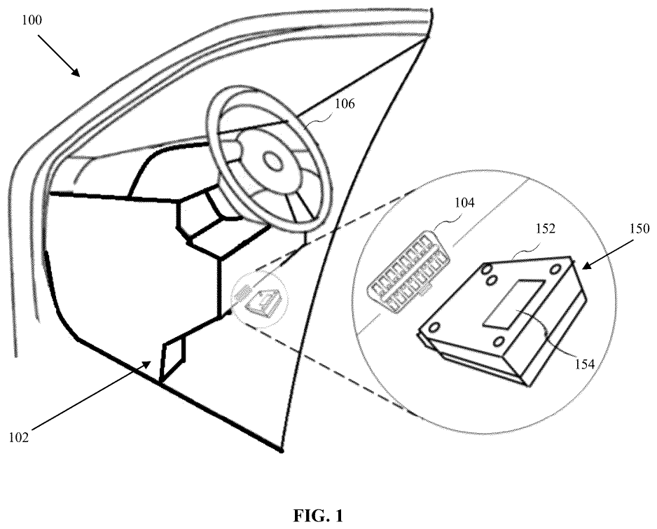

FIG. 1 depicts the front interior 102 on the driver's side of a vehicle 100 with a magnified view of a vehicle diagnostic port 104 and an example apparatus 150 for preserving memory settings and deriving parasitic draw of an electrical system of a vehicle 100, according to an implementation of the present disclosure. Many vehicles have an on-board diagnostics (OBD) port or a cigarette lighter socket/receptacle where devices can be connected to the electrical system of a vehicle. According to one embodiment, the vehicle diagnostic port 104 includes an OBD port, where any OBD tool (e.g., the apparatus 150) can be connected to the electrical system of the vehicle 100. The vehicle 100 may utilize an OBD system, which may essentially include a computer that is used to control and monitor important devices and components of the vehicle through a series of sensors. The OBD system may detect various abnormalities such as, for example, irregularities in the fuel/air mixture, problems with spark plugs, problems with the vehicle's catalytic converter, etc. The vehicle diagnostic port 104 may include a specific plug-in that allows the apparatus 150 to electrically connect to the OBD system to communicate and detect various abnormalities.

Initially, certain automobile manufacturers utilized a vehicle diagnostic port 104 commonly referred to as OBD-1 in accordance with certain standards that would give certain codes for various abnormalities that were not standardized across all vehicle manufacturers. Later, the United States implemented a nationwide standard that is commonly referred to as OBD-2, where all automobile manufacturers utilize a standardized port that can support the same type of scanner with standardized trouble codes. Devices that can be connected via an OBD-2 port can interface with the automobile's computer to retrieve real-time diagnostic data about the automobile. The OBD-2 standard has since been implemented by many nations across the world for standardization purposes. The OBD-2 standard utilizes a 16-pin data link connector (DLC). Specifically, in an automobile, the OBD-2 port of the automobile incorporates a female socket that is generally positioned near a steering wheel 106 of the vehicle 100.

According to various embodiments, the apparatus 150 disclosed herein is configured to connect to the electrical system of the vehicle 100 using OBD-1, OBD-2, or a cigarette lighter socket/receptacle, or various other connection ports. According to one embodiment, the apparatus 150 includes an interface that includes a 16-pin male connector configured to connect to the OBD-2 port of the vehicle 100. Further, the apparatus 150 may include a housing 152 within which various components (e.g., a power source, sensor(s), an analyzer, etc.) are housed. Additionally, the apparatus 150 may include a display 154 for displaying an output that is derived by the apparatus 150, where the output may include a current reading, a voltage reading, a parasitic drain reading, etc.

Within the housing 152, the apparatus 150 includes a power source (e.g., a battery) configured to energize the electrical system of the vehicle 100. According to various embodiments, the power source may include a rechargeable battery. The power source may facilitate preserving memory settings of the vehicle 100 while the primary battery source within the vehicle 100 is disconnected or removed. In particular, the power source may provide voltage and current via the interface so that the cable(s) of the electrical system can be disconnected from the vehicle's battery without losing user-specified settings of the electrical system of the vehicle 100. Advantageously, this functionality allows for disconnecting or replacing the main battery power source of the vehicle 100 while providing temporary power to, in part, preserve adaptations to fuel and spark controls of the engine control modules (ECMs). It is possible that the adaptations can be substantially differentiated from the default fuel and spark trims that the vehicle 100 may not even restart if it were to temporarily lose battery power. Thus, it is very important to preserve the memory settings of the vehicle when the primary battery or power source of the vehicle 100 is disconnected or removed. The apparatus 150 alleviates this concern by providing temporary power to the electrical system of the vehicle 100, which preserves the memory settings of the vehicle.

When a vehicle is operational, an alternator works together with the vehicle's primary power supply to supply power to the electrical components of the vehicle, including the vehicle's battery. In particular, when an alternator pulley is rotated, alternating current (AC) passes through a magnetic field and an electrical current is generated. Specifically, the alternator utilizes rotors that have magnets that move around iron plates of a stator to generate the alternating current in the stator windings. A rectifier can then be used to convert the alternating current to direct current (DC) and power both the electrical components and the vehicle's primary power source or battery. However, when the vehicle is turned off and not in operation, the alternator is not in use and any current draw is being pulled solely from the vehicle's primary power source or battery.

One issue that can lead to problems or complications with the primary power source or battery of the vehicle may stem from a continuous draw from the vehicle's primary power source or battery that is higher than the expected drain while the vehicle is turned off and not in operation. Most vehicles are expected to have a small current draw that is typically less than fifty milliamps (50 mA) when the vehicle is turned off and not in operation in order to maintain memory settings as described above. One reason for this is that various on-board systems turn off at different times and at different rates. In some vehicles, it may take several hours for some systems to fully shut off. Another current draw that exists in some vehicles when the vehicle is turned off and not in operation may include an anti-theft system. Current draw levels below 50 mA are insufficient to drain the vehicle's primary power source or battery. However, when the primary power source or battery is subject to higher levels of current draw when the vehicle is turned off and not in operation, this can unnecessarily cause the vehicle's primary power source or battery to prematurely drain over a relatively short period of time (e.g., over a few days or even overnight) and can shorten the lifespan of the vehicle's primary power source or battery. Battery drain that occurs when the vehicle is turned off and not in operation is commonly referred to as a “parasitic draw” and excessive parasitic draw can lead to parasitic power loss once the battery is sufficiently drained.

In order to measure the parasitic draw levels being exerted on the battery, vehicle technicians often utilize an Ampere meter (i.e., ammeter) or a multimeter (i.e., a tool that possesses the capability of a voltmeter ammeter, and ohmmeter). A common existing method that utilizes the ammeter is to remove the minus (or plus) terminal cable from the vehicle's battery and then connect the ammeter in series between the minus (or plus) pole of the battery and the minus (or plus) terminal of the cable so that the ammeter can display the withdrawal current between the vehicle's battery and the vehicle's battery cable to measure the current levels when the vehicle is turned off and not in operation. This step is followed by individually disconnecting one fuse at a time until the current value from the ammeter drops in order to identify the part of the electrical system that is exerting the parasitic draw. Once the part causing the parasitic draw is located, various other steps can be taken to determine exactly how to replace the part or otherwise resolve the issue. However, removing the minus (or plus) terminal cable from the vehicle's battery in order to utilize the ammeter creates various risks associated with losing memory settings of the vehicle if a backup power source to preserve the memory settings is not simultaneously being used when the battery cable is disconnected.

Because best practice requires vehicle technicians to utilize a backup battery (e.g., a “memory saver”) to preserve the memory settings, it would be advantageous if the device that provides the backup battery could also incorporate the capabilities of the ammeter to measure the parasitic draw. This would eliminate the need for separate tools where one tool could perform the memory saver function and the other tool could measure the current draw. However, unlike existing ammeter systems that detect parasitic draw by connecting the ammeter in series between the minus (or plus) pole of the vehicle's primary battery and the minus (or plus) terminal of the cable, the apparatus 150 measures the current draw on the backup battery itself. Because the backup battery of the apparatus 150 is providing power to the vehicle, measurement of the current being provided by the backup battery 150 would produce the same reading as if the ammeter were to be connected in series between the minus pole of the vehicle's primary battery and the minus (or plus) terminal of the cable. Thus, once the apparatus 150 is connected to the vehicle diagnostic port 104, the vehicle can disconnect one battery terminal and the apparatus 150 can be used to derive the parasitic draw of the electrical system of the vehicle 100.

In particular, the apparatus 150 may include an analyzer that is used to derive the parasitic draw, where the analyzer includes an ammeter capable of detecting current flow from a power source of the apparatus 150 to an electrical system of a vehicle 100 and/or a voltmeter for measuring voltage that is being transmitted from the power source to the electrical system of the vehicle. According to various embodiments, the apparatus 150 includes a display capable of displaying an output reading representing the derived parasitic draw and/or displaying a voltage reading of the measured voltage. According to one embodiment, the display is further capable of displaying a graphical representation of changes in the current flow and the measured voltage over a period of time.

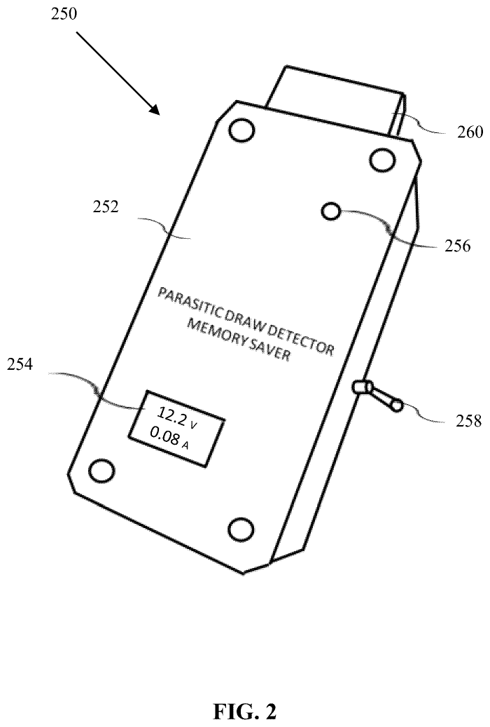

FIG. 2 illustrates a perspective view of an example apparatus 250 for preserving memory settings and deriving parasitic draw of an electrical system of a vehicle, according to an implementation of the present disclosure. The apparatus 250 may include a housing 252 that encloses a power source configured to energize the electrical system of a vehicle and encloses one or more sensors, and an analyzer. For instance, the apparatus 250 may include one or more sensors (e.g., resistor(s)), housed within the housing 252, that are coupled (e.g., connected in series) to the power source of the apparatus 250. The sensor(s) (e.g., resistor(s)) may be configured to detect current flow from the power source of the apparatus 250 that is flowing to the electrical system of the vehicle when the electrical system is disconnected from the vehicle's primary battery source. The sensor(s) (e.g., resistor(s)) may include, according to various embodiments, a moving coil meter or a moving iron meter that when coupled to the power source can detect current flow from the power source to the electrical system of the vehicle. In some embodiments, the sensor(s) may incorporate a small resistor that is placed in parallel with a galvanometer (e.g., an actuator) to shunt most of the current around the galvanometer and direct a pointer in response to electric current flow.

For instance, in one embodiment of a moving coil meter (e.g., a spindle), the sensor(s) (e.g., resistor(s)) may incorporate a set of moving coils with very low resistance and inductive reactance, which allows for low impedance. Further, the sensor(s) may be positioned within the field of fixed magnets set to oppose the current causing a centrally located armature attached to an indicator dial to move. Thus, when current flows through the coil, the coil generates a magnetic field that acts against the fixed magnets causing the coil to twist and the angular deflection is proportional to the current.

In moving iron meter embodiments, the ammeter may incorporate two vanes mounted within a coil, where one vane is fixed and the other vane is free to rotate. When current is applied through the coil, a magnetic field of the same polarity is induced into both vanes, which causes the free vane to be repelled by the fixed vane and the free vane rotates a distance that depends on the strength of the magnetic field, which represents the strength of the current.

As indicated above, the housing 252 may also enclose an analyzer that is electrically coupled to the power source and the sensor(s) (e.g., resistor(s)). According to various embodiments, the analyzer may analyze data in order to identify a pattern or relationship. For instance, the analyzer may analyze data obtained from the sensor(s) (e.g., resistor(s)) in order to quantify or otherwise measure power flow, current flow, voltage, etc. According to various embodiments, the analyzer may include or incorporate a microcomputer, a microcontroller, an analog-to-digital converter (ADC), and/or a microprocessor. For instance, the analyzer may receive analog signals, such as analog voltage signals from current measurement, and the ADC may convert the analog signals to a digital signal or digital data. The digital data may then be provided from the ADC to a processing device, such as a microprocessor, which can perform further analysis, calculations, or formatting of the data. In some example embodiments, the analyzer may incorporate various devices having a processing capability to add software algorithms to derive a parasitic draw of the electrical system of the vehicle. In some embodiments, the analyzer is in communication with a digital display 254 that allows a vehicle technician or other user to monitor the parasitic drain.

According to various embodiments, the analyzer may characterize various measurements or readings detected by the sensor(s) (e.g., resistor(s)). In one embodiment, the reading detected by the sensor(s) (e.g., resistor(s)) is a current flow reading, but various other readings may also be obtained including, but not limited to, impedance, wave forms, current drain, voltage, voltage drop, resistance, etc. and the analyzer may receive an output from the sensor(s) that is then analyzed. The output may include any representative signal of a measurement of one or more parameters of the electrical system of the vehicle. The various components of the analyzer (e.g., processor, microprocessor, microcontroller, microcomputer, analog-to-digital converter, etc.) may utilize the output of the sensor(s) (e.g., resistor(s)) to generate an output signal to the digital display 254 that is representative of the output being measured. The analyzer may incorporate a circuit board assembly comprising a circuit board upon which a microprocessor and the digital display 254 may be connected. Further, the power supply, microcontroller, display driver, and various other components may be interconnected. According to various embodiments, an audible device may be included with the apparatus 250 in order to provide an audible indication of certain operating parameters of the electrical system that are being measured. For example, the audible device may include a piezo element that acts as a speaker to provide an audible output.

According to various embodiments, the analyzer may incorporate an analyzer system comprising various modules, where the modules perform different functionalities. In one example, the analyzer system may incorporate a battery module for deriving battery data, a current flow module for deriving current flow data, a voltage module for deriving voltage data, and the like. The analyzer may perform certain processing functionalities to detect various errors and provide various outputs for the errors. In particular, the analyzer may detect that the parasitic draw is elevated outside of an expected range, which triggers the analyzer to produce an output to alert a user that the parasitic draw is elevated. According to various embodiments, the analyzer may be configured to derive charge voltage, cranking voltage, charging voltage alternator ripple voltage, voltage of the vehicle's primary battery, and the like.

The apparatus 250 may incorporate various input-output (I/O) interfaces. According to one embodiment, the I/O interface may include a wireless connection such as a Bluetooth component or other wireless communication means for wirelessly connecting to an external computing device. In particular, the wireless communication means may be electrically coupled to the analyzer and the wireless communication means facilitates transmitting one or more readings from the analyzer across a network to an external computing device. The I/O interface may include the digital display 254, which may utilize, according to one example, a liquid crystal display (LCD), a light-emitting diode (LED) display, a thin-film transistor LCD, a quantum dot (QLED) display, an organic LED (OLED) display, etc. According to one embodiment, the I/O interface may incorporate a control panel for controlling functionality of the apparatus 250.

Also shown is an example interface 260 that would be electrically coupled to the power source of the apparatus 250. The interface may be configured to be electrically connected to the electrical system of the vehicle. According to various embodiments, the interface may include an auxiliary power outlet and may be configured to be electrically coupled to the electrical system of the vehicle via a direct current connection port. In another embodiment, the interface may include a sixteen-pin connection and is electrically coupled to the electrical system of the vehicle via a port (e.g., a diagnostic port). The apparatus 250 may also include a visual indication (e.g., a light) 256 indicating whether the apparatus is properly connected to the electrical system of the vehicle. The visual indication may be configured as a LED, and more specifically a color changing LED that utilizes, for example, a green color to indicate that the apparatus 250 is properly connected and supplying power to the electrical system of the vehicle or a red color to indicate that the apparatus 250 is not adequately connected.

The apparatus 250 may also include various switches including, for example, a double pole double throw (DPDT) switch 258 that has two inputs and four outputs and is operatively coupled to the analyzer. In particular, each input has two corresponding outputs connected thereto. The DPDT switch may be configured to regulate operation of various components of the apparatus 250. For instance, the DPDT switch 258 may include multiple positional settings, where each positional setting is configured to perform a different measurement related to the electrical system of the vehicle. In one example embodiment, one positional setting may ensure that both the memory saver functionality to preserve the memory settings and the parasitic draw functionality to derive the parasitic draw. Another positional setting may turn off, according to one example, the parasitic draw functionality or another measurement. Other variations of different positional settings and functionality regulations are also contemplated herein.

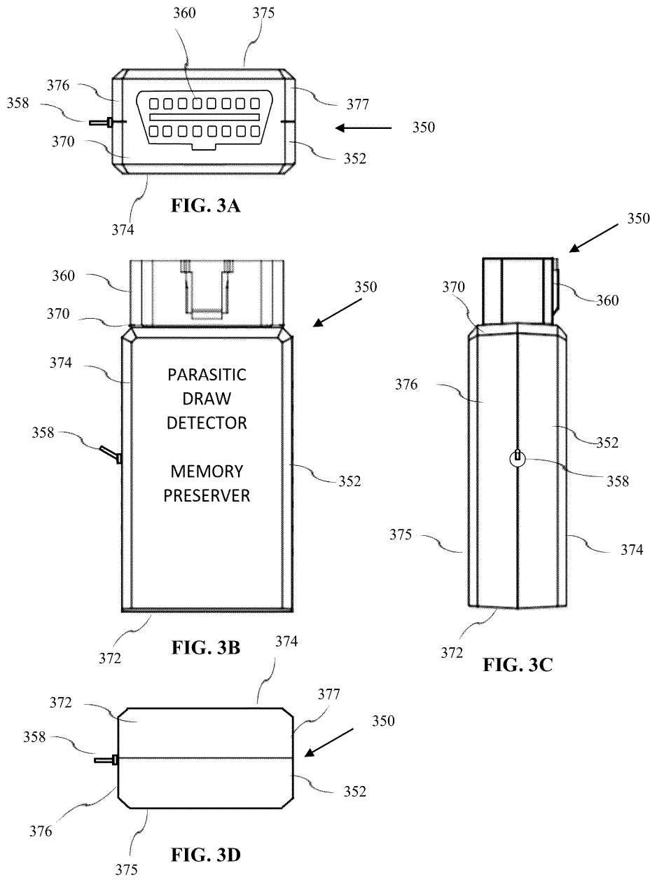

FIGS. 3A-3D illustrate various views of an example apparatus 350 for preserving memory settings and deriving parasitic draw of an electrical system of a vehicle, according to an implementation of the present disclosure. The apparatus 350 may include a housing 352 configured as a generally elongated, hollow rectangular shaped box. The housing 352 includes a front 370 and a back 372, where the front includes an interface 360 extending therefrom. As depicted, the interface 360 may incorporate a 16-pin DLC or some other interface for connecting to the electrical system of the vehicle. The housing 352 may also include a bottom 374, a top 375, a left side 376, and a right side 377. A DPDT switch 358 may protrude from the left side 376 of the apparatus 350. The top 375 and bottom 374 may be generally longer than the front 370 and back 372, and generally wider than the right side 377 and left side 376. According to one embodiment, the housing 352 may include or incorporate a top shell and a bottom shell connected along the left 376, right 377, front 370 and/or back 372 via mechanical fasteners such that when the top shell and bottom shell are aligned together they form the housing 352. Although not depicted, the back 372 may include, according to one embodiment, an aperture or port through which a charging cable may be removably connected.

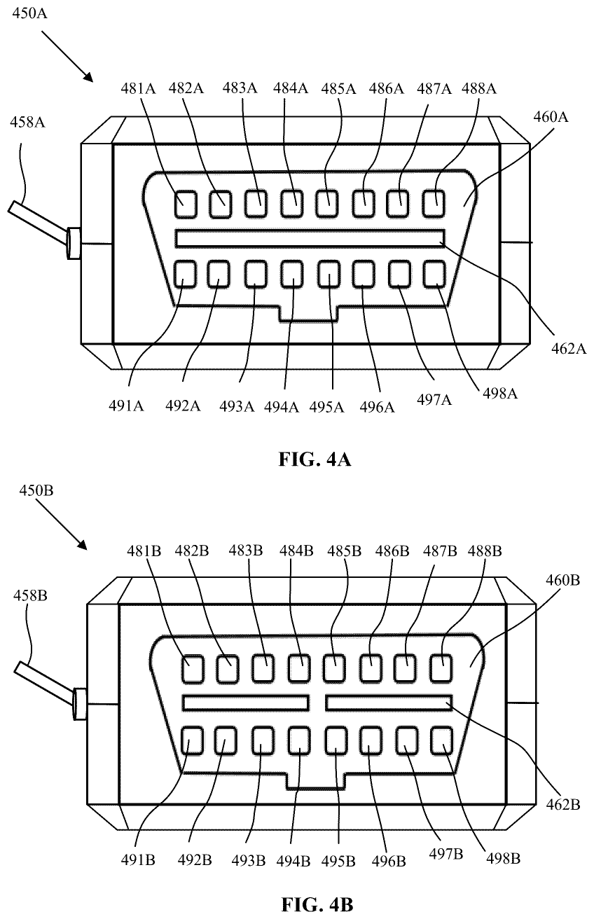

FIGS. 4A and 4B depict a front elevational view of example apparatuses 450A, 450B for preserving memory settings and deriving parasitic draw of an electrical system of a vehicle, according to an implementation of the present disclosure. In particular, apparatus 450A includes a J1962 Type A connection on the interface 460A and apparatus 450B includes a J1962 Type B connection on the interface 460B, which differ based on the shape of the alignment tabs 462A, 462B. Both the J1962 Type A and the J1962 Type B connection are OBD-II compliant connections. Each apparatus 450A, 450B has a respective DPDT switch 458A, 458B.

The J1962 Type A DLC standard indicates that the DLC shall be located in the passenger or driver's compartment in the area bounded by the driver's end of the instrument panel to 300 mm (˜1 ft.) beyond the vehicle centerline, attached to the instrument panel and easy to access from the driver's seat, with the preferred location being between the steering column and the vehicle centerline. The J1962 Type B DLC standard indicates that the DLC shall be located in the passenger or driver's compartment in the area bounded by the driver's end of the instrument panel, including the outer side and an imagined line 750 mm (˜2.5 ft.) beyond the vehicle centerline and attached to the instrument panel for easy access from the driver's seat or from the co-driver's seat or from the outside and mounted to facilitate mating and unmating. Various other OBD-II compliant connections may also include various other protocols such as, for example, J1850 PWM, J1850 VPW, ISO9141-2, ISO14230-4 (also known as Keyword Protocol 2000), ISO15765-4/SAE J2480. Other example interface embodiments, although not depicted, may include a cable and clip configured to fit within a power source receptacle or cigarette lighter receptacle of a vehicle.

The OBD-II standard has some pin locations within the 16-pin DLC that have standardized functionalities and that are required by all vehicle manufacturers. Other pins are left to the individual manufacturer's discretion. For the apparatus 450A (the J1962 Type A DLC) and apparatus 450B (the J1962 Type B DLC) each pin represents a different functionality. For instance, along the first row pins 481A and 481B can be specific to the manufacturer; pins 482A and 482B are bus positive lines; pins 483A and 483B have different functionalities based on the manufacturer (Ford Data Communications Link (DCL) or Chrysler Collision Detection (CCD)); pins 484A and 484B are the chassis ground pins; pins 485A and 485B are signal ground lines; pins 486A and 486B are the computer area network (CAN) high bus lines (which can carry either 2.5V or 3.75V depending on whether they are in idle mode or whether data bits are being transmitted); 487A and 487B are K-lines (bidirectional serial communication line using the K-line protocol); and 488A and 488B are left to the manufacturer's discretion. Further, along the second row pins 491A and 491B, pins 493A and 493B (Ford Data Communications Link (DCL) or Chrysler Collision Detection (CCD)), pins 494A and 494B, and 495A and 495B are left to the manufacturer's discretion; pins 492A and 492B are bus negative lines; pins 496A and 496B are CAN low bus lines (which can carry either 2.5V or 1.25V depending on whether they are in idle mode or whether data bits are being transmitted), pins 497A and 497B are L-lines (unidirectional line used only during initialization to convey address information from a diagnostic tester to the vehicle electronic control units (ECUs); and pins 498A and 498B are battery positive lines.

According to one embodiment, the apparatuses 450A and 450B may provide, when connected via the interface 460A, 460B to the electrical system of the vehicle, 12V DC power via pins 498A or 498B to supply power to the electrical system of the vehicle and will utilize the chassis ground pins 484A and 484B.

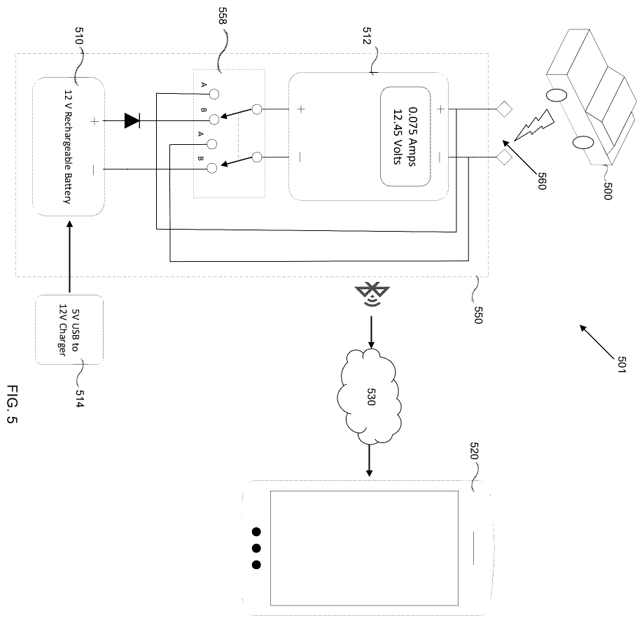

FIG. 5 depicts an example system 501 for preserving memory settings and deriving parasitic draw of an electrical system of a vehicle 500, according to an implementation of the present disclosure. The system 501 includes an apparatus 550 that includes a power source 510 (e.g., a 12V rechargeable battery) that is configured to energize the electrical system of the vehicle 500. Additionally, the apparatus 550 includes an analyzer 512 that is electrically coupled to the power source and also electrically coupled to one or more sensors (e.g., resistor(s)) configured to detect current flow from the power source 510 to the electrical system of the vehicle 500. According to one embodiment, the analyzer 512 comprises the sensor(s) (e.g., resistor(s)) such that the one or more sensors are internal to the analyzer 512 component. The analyzer is configured to derive a parasitic draw of the electrical system of the vehicle 500 based on current flow that is detected by the sensor(s) (e.g., resistor(s)). The apparatus 550 also includes an interface 560 electrically coupled to the power source 510 and that is configured to electrically connect to the electrical system of the vehicle 500.

The apparatus 550 is configured to perform a method based on the apparatus 550 being electrically coupled, via the interface 560 to the electrical system of the vehicle 500 while one or more cables (e.g., the minus terminal cable and/or plus terminal cable) of the electrical system are disconnected from a vehicle battery (e.g., the respective minus pole and/or plus pole). The method includes preserving, by providing power via the power source 510, memory settings of the electrical system of the vehicle 500 and deriving, via the analyzer 512, the parasitic draw of the electrical system of the vehicle 500.

According to one embodiment, the apparatus 550 may include a USB port (e.g., a USB-C port), a wired cord, or other electrical connection means for charging the power source 510 (e.g., due to the power source 510 being rechargeable). For instance, an external power supply 514 may be used to charge the power source 510. The power supply 514 may include, in one particular example, a 5V USB that is used to charge the 12V power source 510. According to various embodiments, the apparatus 550 may be electrically connected to the power supply 514 during operation (i.e., connected to the electrical system of the vehicle 500) or the power source 510 may be charged when not in operation. According to various embodiments, the power supply 514 may connect (via a port) or otherwise be incorporated within the housing of the apparatus 550. According to various embodiments, the power source 510 may have a minimum energy charge capacity of at least 500 milliampere hours (500 mAh), more particularly at least 1,000 mAh, and more preferably at least 1,500 mAh. Further, according to one embodiment, the maximum current output of the power source 510 may be 5 amperes (5 A). According to one embodiment, the power source 510 may include a battery monitor that provides a state of charge of the power source 510.

According to various embodiments, the power source 510 may include various protection mechanisms preventing the power source 510 from providing power to the electrical system of the vehicle 500 while the vehicle 500 is in operation. For instance, if the apparatus 550 is connected to the vehicle 500 while the vehicle 500 is operational, this may cause an overcharging condition. Thus, various conditions may need to be satisfied in order for the power source 510 to transmit power to the electrical system of the vehicle 500.

Although not depicted, the apparatus 550 may also include an I/O interface (e.g., a display), according to various embodiments, that is configured to display a voltage reading, current reading, and/or parasitic draw. For instance, the I/O interface may display a numerical value digitally represented via the display. Accordingly, the method performed by the apparatus 550 of the system 501 may also include displaying, via a display of the apparatus 550, one or more readings derived from the analyzer, where the one or more readings are selected from a voltage reading, current reading, and/or parasitic draw. According to one embodiment, the apparatus 550 may include a selectable display mode that displays, via the display, a graph representing current readings and/or voltage readings over a period of time, which will thereby allow a vehicle technician to monitor the current readings and/or voltage readings over extended periods of time.

According to one embodiment, the I/O interface may incorporate and/or be operatively connected to a drain monitor that displays battery voltage, power consumption, estimated remaining runtime, current consumption, battery temperature, and/or various other measurements. According to various embodiments, the drain monitor may include a shunt-based or voltage-based monitor.

Additionally or alternatively, according to various embodiments, the apparatus 550 may include a communication means for communicating with an external computing device 520 (e.g., a laptop, desktop computer, mobile computing device (i.e., smartphone), portable digital assistant, pager, virtual assistance device such as a smart speaker or other smart home device, or any combination of the aforementioned, or other portable device with processing and communication capabilities). The apparatus 550 may utilize, according to one embodiment, a wired or wireless communication means. For instance, the apparatus 550 may include a radio-frequency transceiver to communicate via Bluetooth with the external computing device 520. In various embodiments, the apparatus 550 may include a Bluetooth communication means (e.g., a Class 2 Bluetooth transceiver), a Wi-Fi communication means, a near-field communication means, and/or other transceivers. Alternatively, the apparatus may connect via a connection port for wired connections via USB, Ethernet, and/or other physically connected modes of data transfer.

In some embodiments, the apparatus 550 may include a transmitter, receiver, transceiver, etc. and/or other communication interface (e.g., an antenna) that provides signals to and/or receives signals from the respective transmitter or receiver of the external computing device 520. According to one embodiment, the apparatus 550 may be configured to operate in accordance with various cellular communication protocols (e.g., second-generation (2G) wireless communication protocols, third-generation (3G) wireless communication protocols, fourth-generation (4G) wireless communication protocols, fifth-generation (5G) wireless communication protocols, and/or the like). In other embodiments, the apparatus 550 may be configured to operate in accordance with non-cellular communication mechanisms, such as via a wireless local area network (WLAN) or other communication data network.

According to various embodiments, the apparatus 550 may communicate via a network 530, which is singly depicted for illustrative convenience, but may include more than one network without departing from the scope of these descriptions. In some embodiments, the network 530 may be or provide one or more cloud-based services or operations. The network 530 may be or include an enterprise or secured network, or may be implemented, at least in part, through one or more connections to the Internet. A portion of the network 530 may be a virtual private network (VPN) or an Intranet. The network 530 can include wired and wireless links, including, as non-limiting examples, 802.11a/b/g/n/ac, 802.20, WiMAX, LTE, and/or any other wireless link. The network 530 may also include one or more local area networks (LANs), radio access networks (RANs), metropolitan area networks (MANs), wide area networks (WANs), personal area networks (PANs), WLANs, campus area network (CAN), metropolitan area network (MAN), storage-area network (SAN), all or a portion of the internet and/or any other communication system or systems at one or more locations. The network 530 may include any internal or external network, networks, sub-network, and combinations of such operable to implement communications between various computing components within and beyond the illustrated system 501.

According to one embodiment, the method further includes transmitting, via a wireless network 530 and by the wireless communication means (e.g., a transceiver), data indicating the derived parasitic draw to the external computing device 520. Additionally or alternatively, the voltage measurement and/or current flow measurement may also be transmitted to the external computing device 520. According to one embodiment, the wireless communication means utilizes short-range radio waves (e.g., Bluetooth technology). In one example, the parasitic draw, voltage measurement, and/or current flow measurement may be communicated to a vehicle technician via a mobile application accessible via the external computing device 520. Advantageously, the wireless communication means may facilitate obtaining a more accurate reading of the parasitic draw. For instance, if the doors of the vehicle 500 are open and various lights (e.g., dome lights, headlamps, etc.) may be turned on, and these additional accessories can affect the parasitic draw reading. Thus, by enabling a vehicle technician or other user to connect the apparatus 550, close the doors, and step away from the vehicle 500 while being able to view the parasitic draw via the external computing device 520, the parasitic draw reading may be more accurate.

According to various embodiments, the data may only be transmitted based on the parasitic draw being outside of an acceptable measurement range. For instance, if the parasitic draw is less than or equal to 50 mA, the data may not be transmitted to the external computing device 520, whereas if the analyzer 512 derives that the parasitic draw is above 50 mA then the apparatus 550 transmits the data to the external computing device 520 indicating that the parasitic draw is above the acceptable range. According to one embodiment, the transmission may take the form of an alert (e.g., visual alert, auditory alert, etc.). For instance, according to one embodiment, the alert may be a notification provided via a mobile application accessible via the external computing device 520. In another embodiment, the alert may take the form of an auditory alarm (provided via the external computing device 520 and/or the apparatus 550). According to various embodiments, different types of alerts may be different based on the measured parasitic draw. For instance, various threshold values (e.g., 25 mA, 50 mA, 100 mA) of parasitic draw may trigger different alerts and/or alert formats.

According to one embodiment, data may be stored, via a storage device (e.g., random access memory (RAM), read-only memory (ROM), volatile memory such as a cache area for temporary storage of data, non-volatile memory that is embedded and/or removable such as electrically erasable programmable read-only memory (EEPROM), flash memory, or the like).

The interface 560 may include a vehicle connection to the OBD diagnostic port (DLC), a cigarette lighter socket/receptacle, or various other connection ports of the vehicle 500. For instance, the negative terminal of the interface 560 may be connected via a chassis ground pin and the positive terminal of the interface 560 may be connected via a battery positive line pin to the female socket of the vehicle 500.

According to one embodiment, the analyzer 512 may perform multiple functions including monitoring voltage and/or current. For instance, according to one embodiment, the sensor(s) (e.g., resistor(s)) may detect voltage drop across a resistor (that is connected in series with the power source 510), and that voltage drop is then converted by the analyzer 512 into a current value using Ohm's law, thereby deriving current flow. According to one embodiment, the analyzer 512 includes an ammeter and/or a voltmeter. The ammeter may include, for example, at least a 0.001 A resolution with the capacity to measure between 0 A-10 A. Further, the voltmeter may include, for example, at least a 0.01V resolution with a capacity to measure between 0V-30V. Depending on the magnitude of the parasitic draw derived by the analyzer 512 that is above the acceptable level (50 mA), one or more processors of the apparatus 550 or the external computing device 520 may identify one or more likely causes of the increased parasitic draw. For instance, if the draw is between 75 mA and 100 mA the analyzer 512 may be configured to determine likely reasons for the increased parasitic draw. In some embodiments in which the parasitic draw reading is transmitted to a mobile application accessible via the external computing device 520, one or more videos and/or links may be displayed via the external computing device 520 instructing the vehicle technician about possible techniques that may be used (e.g., measuring the voltage drop across certain fuses to see which fuses are active) in order to identify the cause of the parasitic draw that would be outside of the acceptable range.

The apparatus 550 may also include an internal/external selector switch, depicted as DPDT switch 558. According to one embodiment, the DPDT switch 558 may include a first position that enables the analyzer 512 to measure voltage from the electrical system of the vehicle 500, and a second position that enables the analyzer 512 to measure voltage and current from the power source 510 to the electrical system of the vehicle 500. According to one embodiment, the power source 510 is electrically coupled to the DPDT switch 558 via a one-way diode, and the DPDT switch 558 is electrically coupled to the analyzer 512.

The apparatus 550 may continue to preserve memory settings and derive parasitic draw of an electrical system of a vehicle 500 for as long as the power source 510 continues to provide power or until the primary battery of the vehicle 500 is reconnected. For instance, once the apparatus 550 detects that the vehicle's battery is reconnected the apparatus may detect that the battery is connected and cut off power to the electrical system of the vehicle 500 so that the power source 510 is no longer providing power to the electrical system and is not used to charge the vehicle's battery.

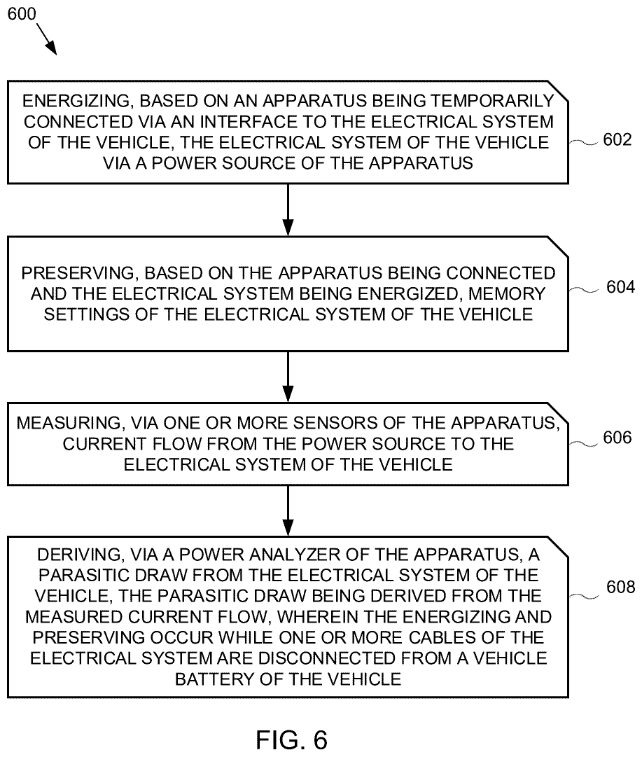

FIG. 6 depicts a block diagram of an example method 600 for preserving memory settings and deriving parasitic draw of an electrical system of a vehicle, according to an implementation of the present disclosure. At block 602, the method 600 includes energizing, based on an apparatus being temporarily connected via an interface to the electrical system of the vehicle, the electrical system of the vehicle via a power source of the apparatus. At block 604, based on the apparatus being connected and the electrical system being energized, memory settings of the electrical system of the vehicle are preserved. At block 606, the method 600 includes measuring, via one or more sensors of the apparatus, current flow from the power source of the apparatus to the electrical system of the vehicle. According to various embodiments, the analyzer includes an ammeter and/or a voltmeter.

At block 608, the method 600 includes deriving, via an analyzer of the apparatus, a parasitic draw from the electrical system of the vehicle, where the parasitic draw is derived from the measured current flow. In particular, the processes described by blocks 602 and block 604 occur while one or more cables of the electrical system are disconnected from a vehicle battery of the vehicle.

According to one embodiment, the method 600 further includes transmitting, via a wireless network and by a wireless communication means of the apparatus, the derived parasitic draw to an external computing device. In one embodiment, based on the analyzer including a voltmeter, the method includes detecting voltage transmitted from the power source to the electrical system of the vehicle.

According to one embodiment, the apparatus includes a double pole double throw switch operatively coupled to the analyzer. The double pole double throw switch includes multiple positional settings, where each positional setting is configured to perform a different measurement related to the electrical system of the vehicle.

Flowcharts and block diagrams depicted in the figures may illustrate functionality and operation of possible implementations of various apparatuses, systems, and methods, according to various embodiments of the present invention. In this regard, each block in the flowcharts and block diagrams may incorporate a specific function or portion of a function. Additionally, the flowcharts and block diagrams may incorporate alternative implementations and the functions noted in the block diagram may occur in a different order from that noted in the figures. For example, two blocks shown in succession may, in fact, be executed substantially concurrently, or the functions noted in the blocks may be implemented in reverse order depending on the functionality involved.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of one or more aspects of the invention and the practical application, and to enable others of ordinary skill in the art to understand one or more aspects of the invention for various embodiments with various modifications as are suited to the particular use contemplated.

It is to be noted that various terms used herein such as “Ford”, “Chrysler”, “Bluetooth”, and the like may be subject to trademark rights in various jurisdictions throughout the world and are used here only in reference to the products or services properly denominated by the marks to the extent that such trademark rights may exist.

What is claimed is:

1. An apparatus for preserving memory settings and deriving parasitic draw of an electrical system of a vehicle, the apparatus comprising:
a power source configured to energize the electrical system of the vehicle;
one or more sensors electrically coupled to the power source, the one or more sensors being configured to detect current flow from the power source to the electrical system of the vehicle;
an analyzer electrically coupled to the power source and the one or more sensors, the analyzer being configured to derive a parasitic draw of the electrical system of the vehicle based on the current flow detected by the one or more sensors; and
an interface electrically coupled to the power source, the interface being configured to electrically connect to the electrical system of the vehicle;
wherein, based on the apparatus being electrically coupled, via the interface, to the electrical system of the vehicle while one or more cables of the electrical system are disconnected from a vehicle battery of the vehicle, the power source preserves memory settings of the electrical system of the vehicle and the analyzer derives the parasitic draw of the electrical system of the vehicle.

2. The apparatus for preserving memory settings and deriving parasitic draw of the electrical system of the vehicle of claim 1, wherein the analyzer comprises an ammeter capable of detecting the current flow.

3. The apparatus for preserving memory settings and deriving parasitic draw of the electrical system of the vehicle of claim 1, further comprising a display capable of displaying an output reading representing the derived parasitic draw.

4. The apparatus for preserving memory settings and deriving parasitic draw of the electrical system of the vehicle of claim 3, wherein the analyzer comprises a voltmeter capable of measuring voltage being transmitted from the power source to the electrical system of the vehicle, and wherein the display is further capable of displaying a voltage reading of the measured voltage.

5. The apparatus for preserving memory settings and deriving parasitic draw of the electrical system of the vehicle of claim 4, wherein the display is further capable of displaying a graphical representation of changes in the current flow and the measured voltage over a period of time.

6. The apparatus for preserving memory settings and deriving parasitic draw of the electrical system of the vehicle of claim 1, further comprising a wireless communication means electrically coupled to the analyzer, the wireless communication means facilitating transmitting across a network one or more readings from the analyzer to an external computing device.

7. The apparatus for preserving memory settings and deriving parasitic draw of the electrical system of the vehicle of claim 1, wherein the interface comprises a sixteen-pin connection and the interface is electrically coupled to the electrical system of the vehicle via a port.

8. The apparatus for preserving memory settings and deriving parasitic draw of the electrical system of the vehicle of claim 7, wherein the port comprises a diagnostic port.

9. The apparatus for preserving memory settings and deriving parasitic draw of the electrical system of the vehicle of claim 1, wherein the apparatus further comprises a double pole double throw switch operatively coupled to the analyzer and comprising multiple positional settings, wherein each positional setting is configured to perform a different measurement related to the electrical system of the vehicle.

10. The apparatus for preserving memory settings and deriving parasitic draw of the electrical system of the vehicle of claim 1, wherein the interface comprises an auxiliary power outlet and is electrically coupled to the electrical system of the vehicle via a direct current connection port.

11. The apparatus for preserving memory settings and deriving parasitic draw of the electrical system of the vehicle of claim 1, wherein a housing houses the power source, the one or more sensors, and the analyzer.

12. A system for preserving memory settings and deriving parasitic draw of an electrical system of a vehicle, the system comprising:
the vehicle comprising the electrical system; and
an apparatus comprising:
a power source configured to energize the electrical system of the vehicle;
one or more sensors electrically coupled to the power source, the one or more sensors being configured to detect current flow from the power source to the electrical system of the vehicle;
an analyzer electrically coupled to the power source and the one or more sensors, the analyzer being configured to derive a parasitic draw of the electrical system of the vehicle based on the current flow detected by the one or more sensors; and
an interface electrically coupled to the power source, the interface being configured to electrically connect to the electrical system of the vehicle;
wherein, based on the apparatus being electrically coupled, via the interface, to the electrical system of the vehicle while one or more cables of the electrical system are disconnected from a vehicle battery of the vehicle, the apparatus is configured to perform a method that includes:
preserving, by providing power via the power source, memory settings of the electrical system of the vehicle;
deriving, via the analyzer, the parasitic draw of the electrical system of the vehicle.

13. The system for preserving memory settings and deriving parasitic draw of an electrical system of a vehicle of claim 12, wherein the apparatus further includes a wireless communication means, and wherein the method further includes transmitting, via a wireless network and by the wireless communication means, data indicating the derived parasitic draw to an external computing device.

14. The system for preserving memory settings and deriving parasitic draw of an electrical system of a vehicle of claim 13, wherein the wireless communication means utilizes short-range radio waves.

15. The system for preserving memory settings and deriving parasitic draw of an electrical system of a vehicle of claim 12, wherein the analyzer comprise an ammeter configured to measure the current flow.

16. A method for preserving memory settings and deriving parasitic draw of an electrical system of a vehicle, the method comprising:
energizing, based on an apparatus being temporarily connected via an interface to the electrical system of the vehicle, the electrical system of the vehicle via a power source of the apparatus;
preserving, based on the apparatus being connected and the electrical system being energized, memory settings of the electrical system of the vehicle;
measuring, via one or more sensors of the apparatus, current flow from the power source to the electrical system of the vehicle; and
deriving, via an analyzer of the apparatus, a parasitic draw from the electrical system of the vehicle, the parasitic draw being derived from the measured current flow;
wherein the energizing and preserving occur while one or more cables of the electrical system are disconnected from a vehicle battery of the vehicle.

17. The method for preserving memory settings and deriving parasitic draw of an electrical system of a vehicle of claim 16, further comprising transmitting, via a wireless network and by a wireless communication means of the apparatus, the derived parasitic draw to an external computing device.

18. The method for preserving memory settings and deriving parasitic draw of an electrical system of a vehicle of claim 16, wherein the analyzer comprises an ammeter.

19. The method for preserving memory settings and deriving parasitic draw of an electrical system of a vehicle of claim 16, wherein the analyzer further includes a voltmeter, and based thereon the method includes detecting voltage transmitted from the power source to the electrical system of the vehicle.

20. The method for preserving memory settings and deriving parasitic draw of an electrical system of a vehicle of claim 16, wherein the apparatus includes a double pole double throw switch operatively coupled to the analyzer and comprising multiple positional settings, wherein each positional setting is configured to perform a different measurement related to the electrical system of the vehicle.
